(19) United States
(12) Patent Application Publication
(10) Pub. No.: US 2026/0357591 A1
(43) Pub. Date: Nov. 12, 2026

(54) MULTI-NOZZLE AUTOMATED ADDITIVE SPRAYING AND METHODS OF ADDITIVE SPRAYING TO FORM FIBER-REINFORCED CONCRETE

(71) Applicant: The Regents of The University of Michigan, Ann Arbor, MI (US)

(72) Inventor: Mania AGHAEI MEIBODI, Ann Arbor, MI (US)

(73) Assignee: The Regents of The University of Michigan, Ann Arbor, MI (US)

(21) Appl. No.: 19/131,444

(22) PCT Filed: Nov. 21, 2023
(86) PCT No.: PCT/US2023/080733

§ 371 Date: May 20, 2025

Related U.S. Application Data
(60) Provisional application No. 63/426,887, filed on Nov. 21, 2022.

(51) Int. Cl. E04G 21/04; B05B 7/14; B05B 12/14; B05B 13/04; B33Y 10/00; B33Y 30/00; B33Y 50/02; B33Y 70/10

(52) U.S. Cl. CPC E04G 21/04; B05B 7/1409; B05B 7/1431; B05B 7/1477; B05B 7/1495; B05B 12/1472; B05B 13/0426; B05B 13/0431; B33Y 10/00; B33Y 30/00; B33Y 50/02; B33Y 70/10

(57) ABSTRACT

An automated spraying device for additive manufacturing with an automated spray head having at least one nozzle in communication with a first supply line and a second supply line configured to deliver at least one sprayed stream comprising fibers and a sprayable slurry matrix material. The automated spraying system is configured to form a layer of reinforced composite material from the at least one sprayed stream comprising fibers and the slurry matrix material on a target. In certain variations, the at least one nozzle includes a first nozzle delivering a first sprayed stream including fibers and a second nozzle delivering a second sprayed stream comprising the sprayable matrix slurry material, and an optional third nozzle delivering a third sprayed stream comprising solid particles. The automated spraying system forms a layer of reinforced composite material from the first and second sprayed streams. Methods including additive spraying such streams are also provided.

### CROSS-REFERENCE TO RELATED APPLICATIONS

This application claims the benefit of U.S. Provisional Application No. 63/426,887, filed on Nov. 21, 2022. The entire disclosure of the above application is incorporated herein by reference.

### FIELD

The present disclosure relates to automated additive spraying with a sprayer device having at least two distinct nozzles for forming fiber-reinforced composites, such as fiber-reinforced concrete, via additive manufacturing.

### BACKGROUND

This section provides background information related to the present disclosure which is not necessarily prior art.

Additive manufacturing (AM) also commonly referred to as three-dimensional (3D) printing, is a process by which material is applied in an additive, layer-by-layer formation technique. Additive manufacturing can form structures having highly complex geometries and freeform shapes and is of particular interest in the construction industry. 3D printing of cementitious materials, like concrete (concrete additive manufacturing or concrete three-dimensional printing—3DP (3DCP)) offers novel opportunities to digitize the construction industry and reduce the carbon dioxide (CO₂) footprint resulting from construction and thus significantly contribute to carbon neutrality by decreasing CO₂ emissions, energy consumption, waste, and costs associated with concrete construction by eliminating the need for formwork and minimizing concrete consumption in building structures. However, traditional extrusion-based 3D concrete printing has unresolved challenges inherent to its processes, such as weak interlayer bonding, high shrinkage, and the need for integrating reinforcements.

Thus, two significant drawbacks that have prevented extrusion-based 3D concrete printing from being widely used in construction is a) the technical challenge of integrating reinforcement (e.g., steel rebar or a sufficient volume of fibers) to provide necessary tensile properties and b) weak layer bonding as a result of the cold joint byproduct of the extrusion process. As a result, concrete 3D printing is used either in compression-only applications (e.g., in wall elements) or as permanent formwork for casting reinforced concrete. While incorporating fiber reinforcement into concrete materials has been an alternative solution to replace steel rebar, the volume of fiber necessary poses processing challenges for extrusion-based methods due to the way it is processes material. Therefore, the fiber-reinforced concrete 3D printing using the extrusion method does not effectively replace rebar reinforcement for many applications. For example, the volume of fiber that is needed to replace rebar reinforcement in typical concrete materials makes it unsuitable as a material used in extrusion-based 3D printing method.

It would be desirable to overcome these fundamental challenges and provide an alternative to extrusion-based 3D printing fiber reinforced concrete.

### SUMMARY

This section provides a general summary of the disclosure, and is not a comprehensive disclosure of its full scope or all of its features.

In certain aspects the present disclosure relates to an automated spraying device for additive manufacturing. The automated spraying device may comprise a feed system comprising a first supply, which may be a first supply line, configured to deliver fibers and a second supply which may be a second supply line, configured to deliver a sprayable slurry matrix material. The automated spraying device may also comprise an automated spray head that comprises at least one nozzle in communication with the first supply, the second supply, or both the first supply and second supply. The at least one nozzle is configured to deliver at least one sprayed stream comprising the fibers and the sprayable slurry matrix material. The automated spraying system is configured to form a layer of reinforced composite material from the at least one sprayed stream comprising the fibers and the sprayable slurry matrix material on a target.

In one aspect, the at least one nozzle includes a first nozzle and a second nozzle and the automated spray head comprises the first nozzle in communication with the first supply and the second nozzle in communication with the second supply. The at least one sprayed stream further comprises a first sprayed stream and a second sprayed stream. The first nozzle is configured to deliver the first sprayed stream comprising fibers and the second nozzle is configured to deliver the second sprayed stream comprising the sprayable slurry matrix material. The automated spraying system is configured to form a layer of reinforced composite material from the first sprayed stream comprising fibers from the first nozzle and the second sprayed stream comprising the sprayable slurry matrix material from the second nozzle on the target.

In one aspect, the automated spray head further comprises a first chamber and a second chamber and the at least one nozzle defines a central region and a peripheral region. The first chamber is in communication with the first supply and the central region of the at least one nozzle and the second chamber is in communication with the second supply and the peripheral region of the at least one nozzle.

In one aspect, the feed system further comprises a fiber chopper that comprises a motor and is configured to chop a feed fiber into the fibers delivered in the first supply to the at least one nozzle.

In one aspect, the automated spray head is disposed on at least one robotic device or a computer numerical control (CNC) gantry.

In one aspect, the automated spray head is at least partially controlled by a computer numerical control (CNC) system.

In one aspect, the at least one nozzle is at least partially controlled individually by a computer numerical control (CNC) system.

In one aspect, the at least one sprayed stream is a pneumatically sprayed stream and the first supply is pressurized and in fluid communication with a first compressed gas source and the second supply is pressurized and in fluid communication with a second compressed gas source.

In one aspect, the fibers are selected from the group consisting of: glass fibers, carbon fibers, plant-based fibers, animal-based fibers, and combinations thereof and the sprayable slurry matrix material comprises an ordinary Portland cement, a fine aggregate, and water.

In one aspect, the automated spray head further comprises an additional nozzle in addition to the at least one nozzle in communication with a third supply, which may be a third supply line, where the additional nozzle is configured to deliver an additional sprayed stream comprising solid particles.

In certain other aspects, the present disclosure relates to an automated spraying device for additive manufacturing. The device may comprise a feed system comprising a first supply line configured to deliver fibers and a second supply line configured to deliver a sprayable slurry matrix material. The automated spraying device also comprises an automated spray head. The automated spray head comprises a first nozzle in communication with the first supply line, where the first nozzle is configured to deliver a first sprayed stream comprising fibers. A second nozzle on the automated spray head is in communication with the second supply line and configured to deliver a second sprayed stream comprising a sprayable slurry matrix material. The automated spraying system is configured to form a layer of reinforced composite material from the first sprayed stream comprising fibers from the first nozzle and the second sprayed stream comprising the sprayable slurry matrix material from the second nozzle on a target.

In one aspect, the automated spray head is disposed on at least one robotic device or a computer numerical control (CNC) gantry.

In one aspect, the automated spray head is at least partially controlled by a computer numerical control (CNC) system.

In one aspect, each of the first nozzle and the second nozzle are at least partially controlled individually by a computer numerical control (CNC) system.

In one aspect, the first sprayed stream is a first pneumatically sprayed stream and the first supply line is pressurized and in fluid communication with a first compressed gas source. Further, the second sprayed stream is a second pneumatically sprayed stream and the second supply line is pressurized and in fluid communication with a second compressed gas source.

In one aspect, the fibers are selected from the group consisting of: glass fibers, carbon fibers, plant-based fibers, animal-based fibers, and combinations thereof and the sprayable slurry matrix material comprises a cement, a fine aggregate, and water.

In one further aspect, the sprayable slurry matrix material comprises an ordinary Portland cement.

In one aspect, the automated spraying device is configured to combine the first sprayed stream comprising fibers from the first nozzle and the second sprayed stream comprising the sprayable slurry matrix material as a combined stream for deposition onto a target to form the layer of reinforced composite material.

In one aspect, the automated spray head further comprises a third nozzle in communication with a third supply line. The third nozzle is configured to deliver a third sprayed stream comprising solid particles.

In one aspect, the feed system further comprises a fiber chopper that comprises a motor configured to chop a feed fiber into the fibers delivered in the first supply line to the first nozzle. The present disclosure also relates to a method of additive spraying of a reinforced composite material. The method may comprise spraying at least one stream comprising fibers and a sprayable slurry matrix material from at least one nozzle on an automated spray head towards a target. The method may also comprise forming a first sprayed layer of reinforced composite material from the at least one stream of the fibers and slurry matrix material on the target. The method further comprises repeating the spraying of the at least one stream forming at least one additional sprayed layer of reinforced composite material over the first sprayed layer.

In one aspect, the spraying at least one stream further comprises spraying a first stream comprising the fibers from a first nozzle on the automated spray head towards the target and spraying a second stream comprising the sprayable slurry matrix material from a second nozzle on the automated spray head towards the target. The forming the first sprayed layer of reinforced composite material comprises the combined first stream and the second stream on the target and the repeating the spraying comprises repeating spraying of the first stream and the second stream and forming the at least one additional sprayed layer of reinforced composite material over the first sprayed layer.

In one further aspect, the spraying of the first stream and the second stream towards the target occur concurrently.

In one further aspect, the first stream and the second stream combine together and are deposited on the target as a combined stream.

In one further aspect, the spraying of the first stream and the second stream towards the target occur sequentially to one another.

In one further aspect, the spraying the first stream occurs at a first flow rate for a first duration so that the fibers are present at a first concentration in the reinforced composite material and the method further comprises adjusting the spraying of the first stream to a second flow rate distinct from the first flow rate for a second duration so that the fibers are present at a second concentration distinct from the first concentration in the reinforced composite.

In one aspect, the fibers are selected from the group consisting of: glass fibers, carbon fibers, plant-based fibers, animal-based fibers, and combinations thereof and the sprayable slurry matrix material comprises an ordinary Portland cement, a fine aggregate, and water.

In one aspect, the method further comprises spraying an additional stream comprising solid particles from an additional nozzle on the automated spray head towards the target. The forming of the first sprayed layer of reinforced composite material comprises the combined at least one stream and the additional stream on the target. The repeating of the spraying of the at least one stream and the additional stream forms the at least one additional sprayed layer of reinforced composite material over the first sprayed layer.

In one aspect, the spraying of the additional stream occurs at a first flow rate for a first duration so that the solid particles are present at a first concentration in the reinforced composite material. The method further comprises adjusting the spraying of the additional stream to a second flow rate distinct from the first flow rate for a second duration so that the solid particles are present at a second concentration distinct from the first concentration in the reinforced composite.

In one aspect, the target is a planar substrate.

In one aspect, the target is a mold or form having a contoured surface.

In one aspect, the target is a previously sprayed layer of reinforced cementitious composite.

In one aspect, the sprayable slurry matrix material is a sprayable cementitious material and the spraying of the at least one stream further comprises introducing an accelerator into the sprayable cementitious material so that mixing occurs in the automated spray head that accelerates activation of the cementitious material.

In one aspect, the method further comprises chopping a feed fiber into the fibers prior to the spraying the at least one stream comprising the fibers.

The present disclosure also further relates to a method of additive spraying of a reinforced composite material. The method comprises spraying a first stream comprising fibers from a first nozzle on an automated spray head towards a target. The method also comprises spraying a second stream comprising a sprayable slurry matrix material from a second nozzle on the automated spray head towards the target. The method comprises forming a first sprayed layer of reinforced composite material of the combined first stream and the second stream on the target. The spraying of the first stream and the second stream is repeated, forming at least one additional sprayed layer of reinforced composite material over the first sprayed layer.

In one aspect, the spraying of the first stream and the second stream towards the target occur concurrently.

In one aspect, the first stream and the second stream combine together and are deposited on the target as a combined stream.

In one aspect, the spraying of the first stream and the second stream towards the target occur sequentially to one another.

In one aspect, the spraying of the first stream occurs at a first flow rate for a first duration so that the fibers are present at a first concentration in the reinforced composite material and the method further comprises adjusting the spraying of the first stream to a second flow rate distinct from the first flow rate for a second duration so that the fibers are present at a second concentration distinct from the first concentration in the reinforced composite.

In one aspect, the fibers are selected from the group consisting of: glass fibers, carbon fibers, plant-based fibers, animal-based fibers, and combinations thereof and the sprayable cementitious material comprises an ordinary Portland cement, a fine aggregate, and water.

In one aspect, the method further comprises spraying a third stream comprising solid particles from a third nozzle on the automated spray head towards the target. The forming of the first sprayed layer of reinforced composite material comprises the combined first stream, the second stream, and the third stream on the target. The method comprises the repeating of the spraying of the first stream, the second stream, and the third stream to form the at least one additional sprayed layer of reinforced composite material over the first layer.

In one further aspect, the spraying of the third stream occurs at a first flow rate for a first duration so that the solid particles are present at a first concentration in the reinforced composite material and the method further comprises adjusting the spraying of the third stream to a second flow rate distinct from the first flow rate for a second duration so that the solid particles are present at a second concentration distinct from the first concentration in the reinforced composite.

In one aspect, the target is a planar substrate.

In one aspect, the target is a mold or form having a contoured surface.

In one aspect, the target is a previously sprayed layer of reinforced cementitious composite.

In one aspect, the sprayable slurry material is a sprayable cementitious material and the spraying of the second stream further comprises introducing an accelerator into the sprayable cementitious material so that mixing occurs in the automated spray head that accelerates activation of the cementitious material.

In one aspect, the spraying of the first stream and the spraying of the second stream are in a radial direction from a central region of a structure formed on the target.

In one aspect, the method further comprises chopping a feed fiber into the fibers prior to the spraying the first stream comprising the fibers.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an automated spraying device prepared in accordance with certain aspects of the present disclosure and configured to conduct an additive spraying process by concurrently generating a first sprayed stream comprising fibers from a first nozzle and a second sprayed stream comprising a sprayable cementitious material (or any other slurry material) from a second nozzle directed towards a target on a planar substrate.

FIG. 2 shows the automated spraying device of FIG. 1 being used to conduct an additive spraying process by concurrently generating a first sprayed stream comprising fibers from a first nozzle and a second sprayed stream comprising a sprayable cementitious material from a second nozzle directed towards a preform or mold having a contoured surface.

FIG. 3 shows an automated spraying device prepared in accordance with certain aspects of the present disclosure and configured to conduct an additive spraying process by concurrently generating a first sprayed stream comprising fibers from a first nozzle, a second sprayed stream comprising a sprayable cementitious material (or any other slurry material) from a second nozzle, and a third sprayed stream comprising solid particles (e.g., gravel) from a third nozzle directed towards a target on a planar substrate.

FIG. 4 shows an automated spraying device prepared in accordance with certain aspects of the present disclosure and configured to conduct an additive spraying process by concurrently generating a first sprayed stream comprising fibers from a first nozzle and a second sprayed stream comprising a sprayable slurry matrix material combined with an accelerator in a spray head that are then sprayed from a second nozzle directed towards a target on a planar substrate.

FIG. 5 shows a cross-sectional view of an example of a sprayed layer applied via the additive spraying methods of the present disclosure having variable properties for functional grading, more specifically, changing the size and density of fibers and granular particles granular across a layer.

FIG. 6 shows a cross-sectional view of an example of a sprayed reinforced composite structure formed via the additive spraying methods of the present disclosure providing an ability to change of resolution across sprayed layers. In the variation shown, a core region is sprayed with larger solid particles and longer fibers (in a slurry of matrix material having a higher viscosity), while a surface of the structure is sprayed with finer material (lacking any solid particles or fibers and formed with a lower viscosity matrix material.

FIG. 7 shows another variation of an automated spraying device prepared in accordance with certain aspects of the present disclosure and configured to conduct an additive spraying process by concurrently generating a first sprayed stream comprising fibers from a first nozzle that is generated by a fiber chopper component and a second sprayed stream comprising a sprayable cementitious material (or any other slurry material) from a second nozzle directed towards a target on a planar substrate.

FIG. 8 shows an automated spraying device prepared in accordance with certain aspects of the present disclosure and configured to conduct an additive spraying process by generating a concentric stream from a nozzle that includes a central region and a surrounding peripheral region, where the central region of the nozzle sprays fibers and the peripheral region sprays a sprayable cementitious material (or any other slurry material) towards a target on a planar substrate.

FIG. 9 shows an automated spray head that may be used with the automated spraying device in FIG. 8 prepared in accordance with certain aspects of the present disclosure where a feed system in the spray head has a fiber chopper component that generates the fibers for spraying in the central region of the nozzle and a slurry delivery system delivers a sprayable cementitious material (or any other slurry material) to the peripheral region of the nozzle to generate the concentric stream. The concentric stream is a pneumatically sprayed stream having a first pressurized supply line in fluid communication with a first compressed gas source and a second pressurized supply line is pressurized and in fluid communication with a second compressed gas source.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-Ray Disc).

The apparatuses and methods described in this application may be partially or fully implemented by a special purpose computer created by configuring a general purpose computer to execute one or more particular functions embodied in computer programs. Any functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In various aspects, the present disclosure provides an alternative method of additive manufacturing from extrusion-based 3D printing of fiber-reinforced concrete. The present disclosure contemplates an automated additive spraying process that can be done with robotics and other computer numerical control (CNC) driven machinery in certain variations. For example, the methods of additive spraying of a cementitious material may comprise spraying a stream comprising a reinforcement phase or material, such as fibers, on an automated spray head towards a target.

In certain aspects, a method of additive spraying of a reinforced composite material includes spraying at least one stream comprising a reinforcement phase, such as fibers, and a sprayable slurry matrix material from at least one nozzle on an automated spray head towards a target. The at least one nozzle may be a single nozzle or two or more nozzles, as described further below. In certain variations, the at least one stream may be a single sprayed stream, such as a concentric stream where a central region includes the fibers and a peripheral region that includes the sprayable slurry material. The at least one stream may also comprise two or more distinct sprayed streams, as described below. The method may also comprise forming a first sprayed layer of reinforced composite material from the at least one stream of the fibers and slurry matrix material on the target. The method further comprises repeating the spraying of the at least one stream forming at least one additional sprayed layer of reinforced composite material over the first sprayed layer.

In certain variations, the methods of additive spraying of a cementitious material may comprise spraying a first stream comprising a reinforcement phase or material, such as fibers, from a first nozzle on an automated spray head towards a target. The method also comprises spraying a second stream comprising a sprayable cementitious (e.g., matrix slurry) material from a second nozzle on the automated spray head towards the target. In this manner, a first sprayed layer of reinforced cementitious composite is formed from the combined first stream and the second stream on the target. However, it will be appreciated that the present methods and devices may be used to form not only fiber-reinforced concrete with a cementitious material as in the variations generally described herein, but alternatively can form other fiber-reinforced composites made of any kind of fiber (including plant-based fibers) with any slurry that includes a powder (e.g., in additional to cementitious cement-based powders and supplementary cementitious materials, such as fly ash, flower-based materials, soil-based materials, clay, and the like) and granular material (such as sand, fines, and coats aggregate). However, in certain variations, the present disclosure contemplates the additive spraying of cementitious materials and fibers as generally discussed herein. It will be appreciated by that the discussion herein may more broadly apply to the alternative materials, as well.

In certain other aspects, the methods of additive spraying of a cementitious material may comprise spraying a third stream comprising an aggregate or granular material from an optional third nozzle on the automated spray head towards the target.

In certain aspects, the methods may comprise concurrently spraying the first stream and the second stream towards the target. The first stream and the second stream may at least partially combine prior to hitting the target. In variations where the third stream is present, it may likewise be concurrently sprayed with the first and second streams towards the target and may at least partially combine with them prior to hitting the target. In other aspects, the first stream, the second stream, and optional third stream may be directed in a manner such that their combination and mixing occurs on the target itself. In other variations, the methods may comprise successively spraying the first stream and then the second stream towards the target, thus forming a first layer from the first stream and a second layer over the first layer formed by the second stream. Where the third stream is present, it may be successively applied on the target, as well.

In certain variations, the methods may comprise controlling and modifying a concentration of fibers present in the reinforced cementitious composite material formed over the target. All three nozzles may have a digitally variable and adjustable flow rate. For example, the spraying of the first stream may occur at a first flow rate for a first duration so that the fibers are present at a first concentration in the reinforced cementitious composite. The method may then further comprise adjusting the spraying of the first stream to a second flow rate distinct from the first flow rate for a second duration so that the fibers are present at a second concentration distinct from the first composition in the reinforced cementitious composite. This adjustment of fiber concentration may be done in a single sprayed layer or interspersed in different sprayed layers (where each layer may have a different concentration of fibers in the reinforced cementitious composite). Notably, the flow rates may be adjusted as needed and are not limited to only two flow rates, but may be highly variable, for example, adding higher concentrations of fibers for reinforcement in high stress areas of a structure, while providing lower concentrations of fibers in areas of a structure experiencing lower potential stress in service. In this manner, the methods of the present disclosure contemplate tailoring volume fraction fiber (VFF) in the reinforced cementitious composite and thus enables functional grading of the tensile property of the material.

In certain other variations, where a third stream is generated by a third nozzle present on the automated spray head, the methods may comprise controlling and modifying a concentration of aggregate present in the reinforced cementitious composite material formed over the target. For example, the spraying of the third stream may occur at a first flow rate for a first duration so that the aggregate particles are present at a first concentration in the reinforced cementitious composite. The method may then further comprise adjusting the spraying of the third stream to a second flow rate distinct from the first flow rate for a second duration so that the aggregate particles are present at a second concentration distinct from the first composition in the reinforced cementitious composite. This adjustment of particle/aggregate concentration may be done in a single sprayed layer or interspersed in different sprayed layers (where each layer may have a different concentration of granular particles or aggregates in the reinforced cementitious composite). Notably, the flow rates may be adjusted as needed and are not limited to only two flow rates, but may be highly variable, for example, adding higher concentrations of aggregate or granular particles in select areas of a structure, while providing lower concentrations of aggregate or granular particles in other areas of a structure. Further, the methods of the present disclosure may spray different particulate or granular materials, for example, successively spraying particles having diameters ranging from a fine particle size to a larger coarse particle size defining distinct layers with distinct particles sizes or a gradient of particle sizes within the reinforced cementitious composite. Similar to the additive spraying with the fibers, the methods allow for varying the size of the granules or aggregates in different regions of the reinforced cementitious composite. In this manner, the methods of the present disclosure allow the reduction of shrinkage and control of the resolution of the 3D printed parts. Further, a core with a coated material can be formed by additive spraying. For example, the core may be formed with a first reinforced cementitious composite composition having a granular particle or aggregate with a first particle size, which is then coated with a second reinforced cementitious composite having finer or smaller grain size granular particles or aggregates.

The methods include repeating the spraying of the first stream, the second stream, and optional third stream, and forming at least one additional sprayed layer of reinforced cementitious composite over the first layer that is disposed on the target. In certain aspects, in the final or last layers applied, the spraying of the fiber from the first stream and/or spraying of the aggregate from the optional third stream may be discontinued, so that the final layers are free of fiber reinforcement and/or free of aggregate. In this manner, a physical structure can be built in a flexible, automated, layer-by-layer additive manufacturing process without requiring traditional reinforcements (e.g., rebar) or extrusion. In certain variations, the methods provided by the present disclosure may be referred to as Multi Nozzle Robotic Additive Spraying (MNRAS or RAS). RAS is a robotic-controlled manufacturing process that uses compressed gases, such as compressed air, to spray various materials from independent nozzles under pressure to fabricate concrete structures in layers. The additive manufacturing methods conducted in this manner can overcome traditional challenges such as better interlayer bonding, due to the high kinetic energy associated with pressurized material deposition from the streams in MNRAS. MNRAS uses at least two distinct nozzles to concurrently or simultaneously spray fibers, such as carbon and/or glass fibers, with a flowable or liquid concrete material, for the enhanced tensile properties. Because MNRAS deposits carbon/glass fiber with wet mortar in successive layers from separate nozzles, it enables on-demand modulation of fiber amount (for example, tailoring volume fraction fiber (VFF)) and thus enables functional grading of the tensile property.

Moreover, the MNRAS methods and additive spraying device is versatile. As materials are deposited from separate nozzles, it is contemplated that an increased number of nozzles may be used in the system, for example, permitting depositing of aggregates (both fines and coarse) in addition to the depositing of carbon/glass fibers with wet mortar in successive layers from separate nozzles. The process enables on-demand modulation of fiber amount, aggregates, and motor concrete. For example, tailoring the size of the aggregates (larger at the core and finer as at the surface of the 3D printed parts) and thus enables high resolution surface finishing while keeping the strength needed for reducing cracks.

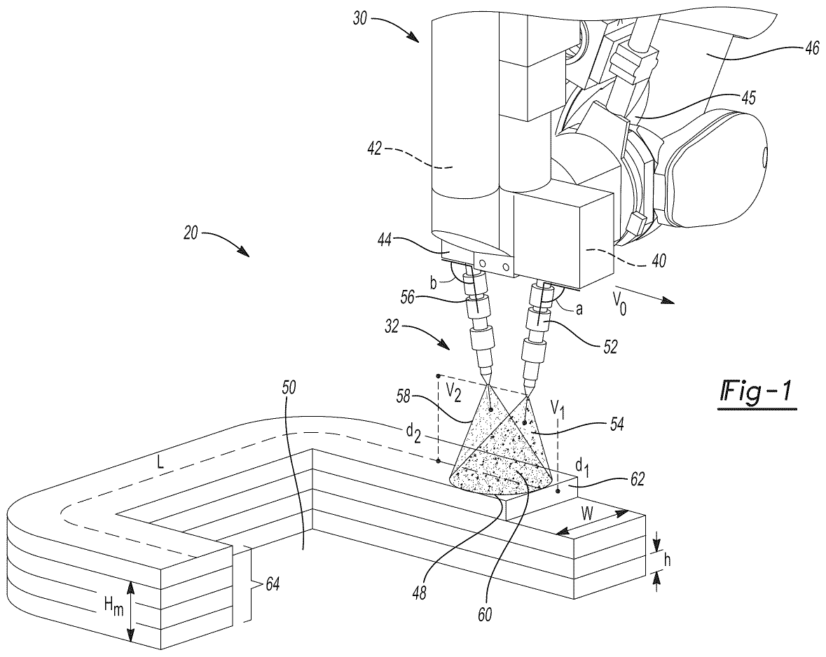

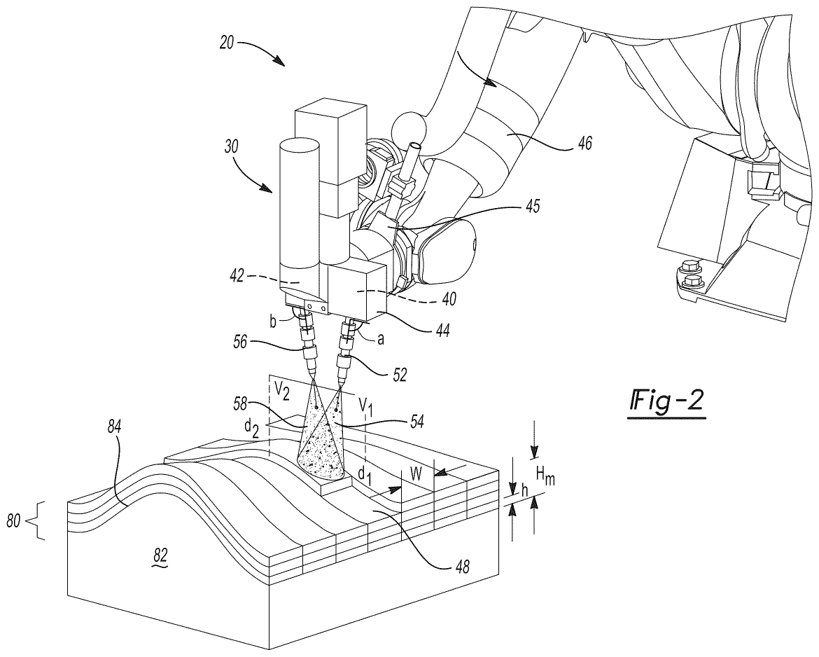

FIGS. 1 and 2 show an automated spraying device 20 for additive manufacturing. The device 20 comprises a feed system 30 and an automated spray system 32. The feed system 30 includes a first supply line 40 configured to deliver fibers. The feed system 30 also includes a second supply line 42 that is configured to deliver a sprayable cementitious material (or in alternative variations, a low viscosity slurry), which will be described further below. While not shown in FIGS. 1 and 2, the first supply line 40 may be in fluid communication with a pressurized gas, such as a first compressed gas source, like compressed air, such that the compressed gas and fibers supplied by an upstream fiber supply are combined together in the first supply line 40 to create a first pressurized pneumatic spray stream described below. Likewise, the second supply line 42 may be in fluid communication with a pressurized gas, such as a second compressed gas source, like compressed air, such that the compressed gas and cementitious material supplied by an upstream cementitious material source combine together in the second supply line 42 to create a second pressurized pneumatic spray stream described below. Notably, the first and second compressed gas sources may be the same or different from one another.

The automated spray system 32 includes an automated spray head 44, which may be digitally controlled. The automated spray head 44 is connected to a robotic arm 46 that has one or more actuators 45 and is connected to at least one controller (not shown) for translating the automated spray head 44 with respect to a target 48 disposed on a substrate 50 on which an additively manufactured fiber-reinforced cementitious composite structure 64 is being built. In certain aspects, the automated spray system 32 may be part of a robotic device, such as a computer numerical control (CNC) machine, with a tiltable spray head 44 having a specially designed nozzles that form the multilayered additively manufactured fiber-reinforced cementitious composite structure 64. Such machines have automation with advanced CNC machinery and highly articulated degrees of customization in directionality. The CNC machinery may include a computer processing unit (CPU) and one or more controllers that may be operated with various modules, as appreciated by those of skill in the art. Thus, an overall additive manufacturing system may comprise a CNC or robotic controlled automated spray system 32 that includes the automated spray head 44, which synchronously deposits a cementitious fiber-reinforced material from at least two distinct nozzles in the spray head in subsequent layers to form a monolithic solid structure. In certain aspects, the monolithic solid formed comprises at least one wall. The layers can be variable in thickness (e.g., height of each respective deposited layer), as controlled by the change in height between layers combined with the rate of spraying.

Notably, FIG. 1 shows the substrate being a flat planar surface, like the ground or a floor structure. While FIGS. 1 and 2, show vertical 3D spraying, while not shown, the processes and devices described herein can also be used for nonplanar spraying and nonvertical spraying, for example, horizontally 3D spraying on an existing wall.

The automated spray head 44 includes nozzles that may independently have a digitally variable and adjustable flow rate. For example, the automated spray head 44 comprises a first nozzle 52 in communication with the first supply line 40. The first nozzle 52 is configured to deliver a first sprayed stream 54 comprising fibers directed towards the target 48. The first nozzle 52 may be digitally controlled. The automated spray head 44 also includes a second nozzle 56 that is in communication with the second supply line 42 and is configured to deliver a second sprayed stream 58 comprising a sprayable cementitious material towards the target 48. The second nozzle 56 may also be digitally controlled. As shown in FIGS. 1 and 2, the first and second nozzles, 52, 56 can be oriented in the automated spraying system 32 so that the first sprayed stream 54 comprising fibers from the first nozzle 52 and the second sprayed stream 58 comprising the sprayable cementitious material from the second nozzle 56 are combined and mixed together to form a combined stream 60. The combined stream 60 includes both the fibers and the sprayable cementitious material and is thus deposited on target 48 as a top layer 62 of the multilayered additively manufactured fiber-reinforced cementitious composite structure 64 being formed on the substrate 50.

An additive spraying process in accordance with certain aspects of the present disclosure can be conducted on the automated spraying device 20 with a concrete and fiber sprayed from the two separate nozzles, first nozzle 52 and second nozzle 56. The digitally controlled automated spray head 44 moves at the velocity “V₀,” where each respective first nozzle 52 and second nozzle 56 has a distances of “d₁” and “d₂” from the successfully printed layer (e.g., uppermost top layer 62) and with the angles of “a” and “b” with respect to the automated spray head 44. The first nozzle 52 is spraying fiber at the velocity “V₁,” and the second nozzle 56 is spraying the cementitious mortar at velocity “V₂.” In this manner, distinct layers of individually selected height “h,” and width “w” can be formed. The overall height (Hₘ) of the cementitious composite structure 64 will be the number of counter lengths multiplied by one height.

FIG. 2 shows the same automated spraying device 20 but being used to form an additively manufactured fiber-reinforced cementitious composite structure 80 on a mold or form 82, which may have a shaped, non-planar, and/or contoured surface 84. Thus, the target 84 is disposed on the contoured surface 84. In this manner, the first nozzle 52 and the second nozzle 56 may be controlled to deposit the sprayed layers of reinforced cementitious composite material at varying angles that change with position of the automated spray head 44 as it passes over the contoured surface 84.

The automated spraying device of FIG. 1 can be used to conduct a functionally graded additive spraying process by varying the length of fiber and fiber density while situationally spraying cementitious material from a second nozzle. For example, a length of the deposited fibers and/or a density of deposited fibers may vary by varying the fibers in the first sprayed stream 54 being sprayed from the first nozzle 52, while concurrently or simultaneously spraying a slurry comprising cementitious material from the second nozzle 56 generating the second sprayed stream 58. In this manner, distinct layers with distinct compositions are created (having differing lengths of fibers and/or different deposited fiber density).

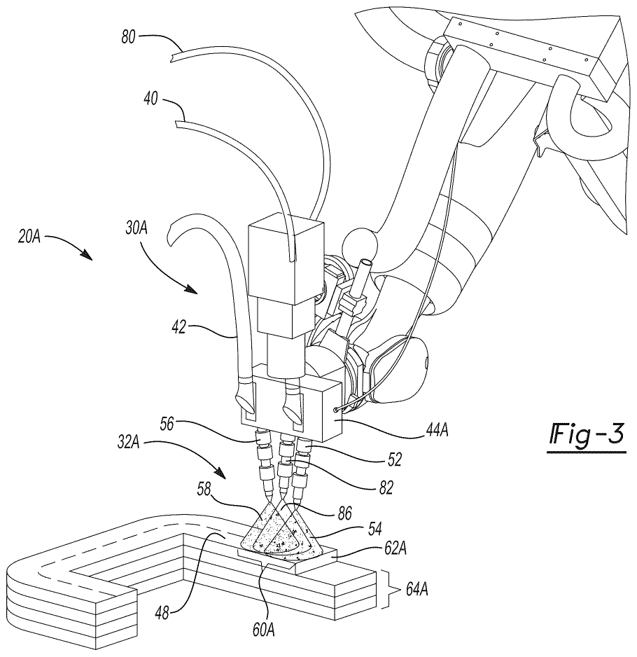

FIG. 3 shows another variation of an automated spraying device 20A for additive manufacturing. The device 20A comprises a feed system 30 and an automated spray system 32. To the extent that the components are the same or similar in function to those in automated spraying devices 20, 20A, 20B discussed above in the context of FIGS. 1-4, they will not be reintroduced or discussed again herein for brevity. The feed system 30A includes a first supply line 40 configured to deliver fibers, which as described above may be pneumatic and in fluid communication with a pressurized gas. The feed system 30A also includes a second supply line 42 that is configured to deliver a sprayable cementitious material (or in alternative variations, a low viscosity slurry), which as described above may be pneumatic and in fluid communication with a pressurized gas. The feed system 30A further includes a third supply line 80 configured to deliver aggregates or solid particles (having a non-fibrous shape, for example, gravel).

An automated spray system 32A includes an automated spray head 44A, which may be digitally controlled as discussed above. The automated spray head 44A includes a first nozzle 52 in communication with the first supply line 40. The first nozzle 52 is configured to deliver a first sprayed stream 54 comprising fibers directed towards the target 48. The first nozzle 52 may be digitally controlled. The automated spray head 44A also includes a second nozzle 56 that is in communication with the second supply line 42 and is configured to deliver a second sprayed stream 58 comprising a sprayable cementitious material towards the target 48. The second nozzle 56 may also be digitally controlled. The automated spray head 44A further includes a third nozzle 82 is configured to deliver a third sprayed stream 86 comprising aggregates or solid particles (such as gravel) directed towards the target 48. The third nozzle 82 may also be digitally controlled. In certain aspects, the third nozzle 82 may concurrently or simultaneously for third sprayed stream 86 that sprays granular mixes having particles with average diameters ranging from greater than or equal to about 0.1 mm to less than or equal to about 7 mm.

As shown in FIG. 3, the first, second, and third nozzles, 52, 56, 82 can be oriented in the automated spraying system 32A so that the first sprayed stream 54 comprising fibers from the first nozzle 52 and the second sprayed stream 58 comprising the sprayable cementitious material from the second nozzle 56 and the third sprayed stream 86 comprising aggregates are combined and mixed together to form an overlapping combined stream 60A. The combined stream 60A includes the fibers, the aggregates, and the sprayable cementitious material and is thus deposited on target 48 as a top layer 62A of a multilayered additively manufactured fiber-reinforced cementitious composite structure 64A.

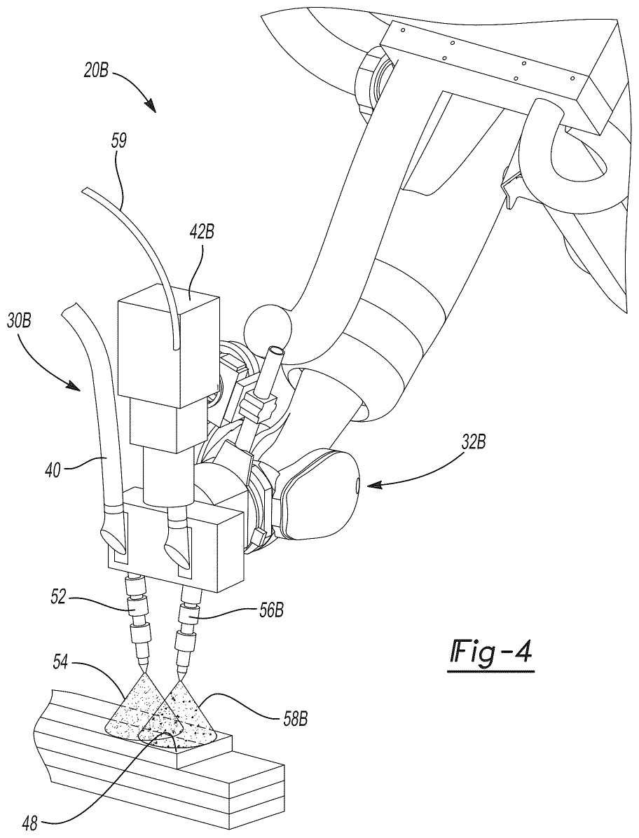

FIG. 4 shows yet another variation of an automated spraying device 20B used to form an additively manufactured fiber-reinforced cementitious composite structure similar to the automated spraying devices automated spraying devices 20 and 20A in FIGS. 1 to 3. To the extent that the components are the same in the automated spraying device 20B as in the automated spraying device 20 or automated spray device 20A, the components will have the same numbering and unless otherwise addressed have the same function as design as those in FIG. 1. In the automated spraying device 20B, additives, such as accelerator, may be introduced to the second supply line 42B that is configured to deliver the sprayable cementitious material or low viscosity slurry. Thus, the automated spray system 32B includes an automated spray head 44B, which may be digitally controlled as discussed above. The automated spray head 44B includes a first nozzle 52 in communication with the first supply line 40. The first nozzle 52 is configured to deliver a first sprayed stream 54 comprising fibers directed towards the target 48. The first nozzle 52 may be digitally controlled. The automated spray head 44B also includes a second nozzle 56B that is in communication with the second supply line 42B and is configured to deliver a second sprayed stream 58B comprising a sprayable cementitious material towards the target 48. The second nozzle 56 may also be digitally controlled.

For example, where the sprayable slurry material is a sprayable cementitious material, for example, comprising ordinary Portland cement, the spraying of the second sprayed stream 58B may further comprise introducing an accelerator via an accelerator supply line 59 (connected to an upstream supply of accelerator or additive not shown in FIG. 4) into the sprayable cementitious material either within the second supply line 42B (or in a feed chamber) so that mixing occurs in the automated spray head 44B. The addition of the accelerator thus accelerates activation and setting of the cementitious material as it is applied to the target 48.

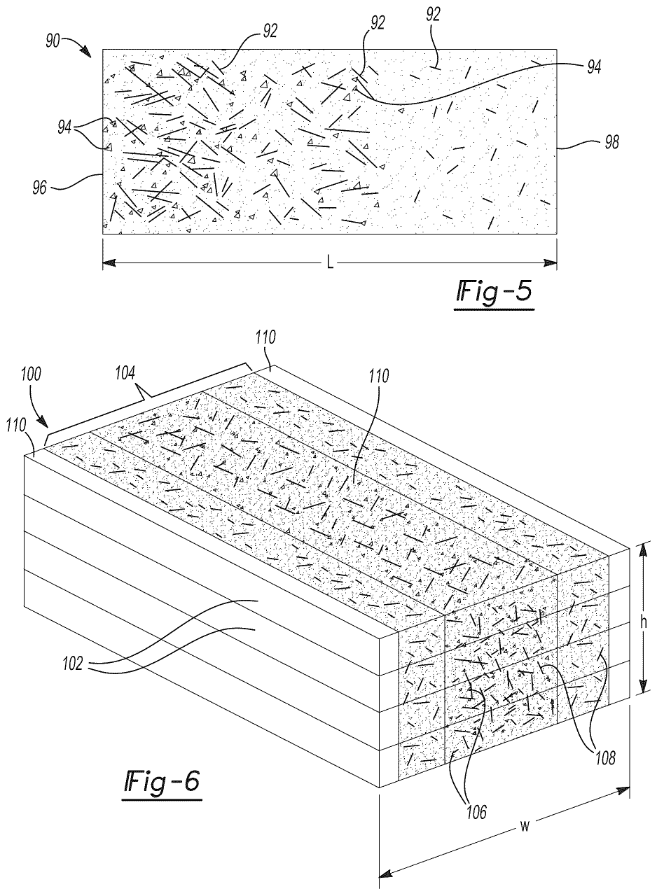

FIG. 5 shows a cross-sectional view of an example of a sprayed layer 90 applied via the additive spraying methods of the present disclosure having variable properties for functional grading. As shown, the reinforcement phase comprises both fibers 92 and granular particles 94 across a dimensions, here shown as a non-limiting example of length (“L”) of the layer 90. The fibers 92 and granular particles 94 are varied in both size and density from a first (e.g., left) side 96 to a second (e.g., right) side 98. The first side 96 has a high density or high concentration of fibers 92 and particles 94, where the fibers 92 are relatively long and the particles 94 are relatively large. The second side 98 has lower density or lower concentration of particles 94 and fibers 92, where the fibers 92 are shorter and the particles 94 are smaller.

The present technology further allows for additive deposition of material along the surface dimensions. FIG. 6 shows a cross-sectional view of an example of a sprayed reinforced composite structure 100 formed via the additive spraying methods of the present disclosure providing an ability to change of resolution across sprayed layers 102. In the variation shown, a core region 104 is sprayed with larger solid particles 106 and longer fibers 108 (in a slurry of matrix material having a higher viscosity), while a surface (here shown as two terminal surfaces 110) of the structure 100 is sprayed with finer material (lacking any solid particles or fibers) and formed with a lower viscosity matrix material, such as a slurry, which may vary in kind. As shown in FIG. 6, the present disclosure provides the ability for concurrent/simultaneous or progressive additive spraying with different material resolutions. In this example, a core region 104 is sprayed with larger granules/particles 106, larger fibers 108, and a slurry of higher viscosity, material, while the outermost surface is sprayed with finer grained material (for example, free of granules/particles 106 and fibers 108 and only containing a low viscosity slurry). In this manner, controlled material deposition not only occurs in a vertical direction (designated “h” for height), but also along a surface dimension or in a radial direction from a center of the structure (e.g., from the core 104 going outward) designated “w” for width.

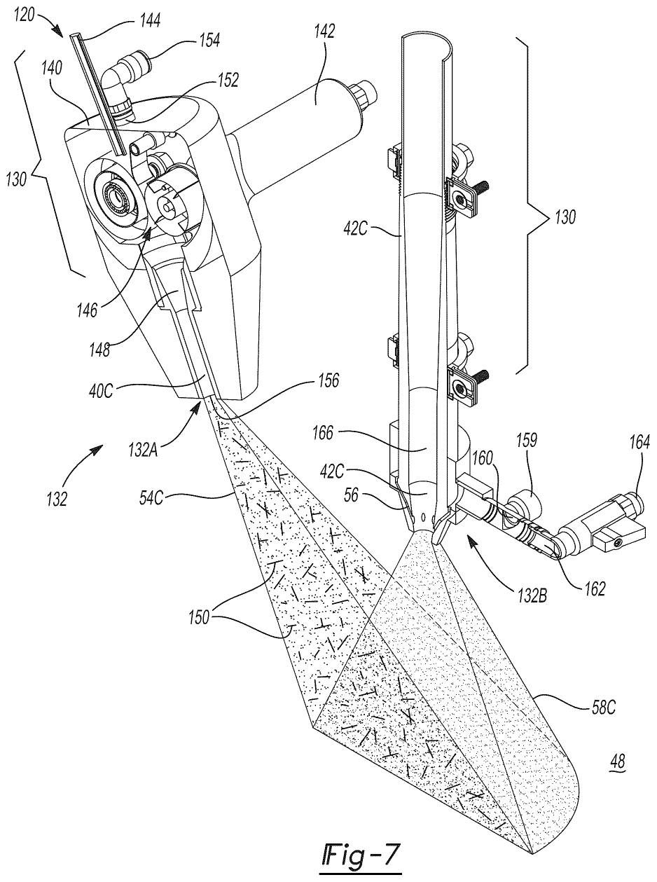

FIG. 7 shows another variation of an automated spraying device 120 prepared in accordance with certain aspects of the present disclosure, which includes a variation to the fiber feeding system. Further, additives, such as accelerator, may be introduced to the second supply line configured to deliver the sprayable cementitious material or low viscosity slurry. The device 120 comprises a feed system 130 and an automated spray system 132 that includes subsystems 132A and 132B, discussed in further detail below. To the extent that the components of automated spraying device 120 are the same or similar in function to those in automated spraying devices 20, 20A, 20B discussed above in the context of FIGS. 1-4, they will not be reintroduced or discussed again herein for brevity. The feed system 130 includes a first supply line 40C configured to deliver fibers. The first supply line 40C is associated and in communication with a fiber chopper device 140. The fiber chopper device 140 has a motor 142 that chops a feed fiber 144 in an internal chopping region 146 including various internal chopping rollers and components that form part of a chopping mechanism. The feed fiber 144 may be an elongated and continuous fiber that is chopped at predetermined points to generate a plurality of discrete chopped fibers 150 having a predetermined length corresponding to the chopping frequency selected by a user. This may be achieved by adjusting the configuration of the choppers in a fiber chopping region where the components of the internal chopping region 146 operate, so that one configuration results in shorter fibers whereas a second configuration results in longer fibers. In this manner, a length of the fibers may be adjusted by changing the configuration of the chopping section in the spray chopper (fiber chopping device 140) so that there are fewer chops per rotation of the rollers in the internal chopping region 146. Generally, longer fibers can result in a higher strength and stiffer material, whereas shorter fibers provide a more flexible material. As will be appreciated, the length of the chopped fibers 150 may thus be dynamically controlled during operation of the fiber chopper device 140 to generate fibers of varying lengths, as discussed in the context of FIGS. 5 and 6 above. As described above, the first supply 40C may be pneumatic and in fluid communication with a pressurized gas. In this variation, the fiber chopper device 140 also has an inlet 152 that receives a pressurized gas (e.g., air) supply 154. The pressurized air from the pressurized air supply 154 and chopped fibers 150 then pass into a fiber cavity 148, where a pressurized pneumatic stream of fibers flows as the first supply 40C.

As shown, the automated spray system 132 may be bifurcated to have two separately controlled supplies (first supply line 40C is shown as part of first automated spray subsystem 132A and a second supply line 42C is shown as part of second automated spray subsystem 132B), but may be digitally controlled and coordinated with one another like embodiments discussed above as discussed above. The first supply line 40C may or may not include a separate nozzle. For example, the first supply 40C may deliver first sprayed stream 54 directly from the fiber chopper device 140 at an outlet 156 that may be an orifice (or optionally having an integrated nozzle component). The outlet 156 is configured to deliver the first sprayed stream 54C comprising fibers directed towards the target 48. Again, the nozzle or outlet 156 of the fiber chopper device 140 may be digitally controlled.

In the automated spraying device 120, additives, such as accelerator, may be introduced to the second supply line 42C that is configured to deliver the sprayable cementitious material or low viscosity slurry. The second automated spray subsystem 132B also includes a second nozzle 56 that is in communication with the second supply line 42C and is configured to deliver a second sprayed stream 58C comprising a sprayable cementitious material directed towards the target 48. The second nozzle 56 may also be digitally controlled.

For example, where the sprayable slurry material is a sprayable cementitious material, for example, comprising ordinary Portland cement, the spraying of the second sprayed stream 58C may further comprise introducing an accelerator via an accelerator supply line 159 (connected to an upstream supply of accelerator or additive not shown in FIG. 7) that enter an inlet 160 of line 162. As described above, the second supply 42C may be pneumatic and in fluid communication with a pressurized gas. Thus, the line 162 receives a pressurized gas (e.g., air) supply 164, for example, from a compressed gas source. The pressurized air from the pressurized air supply 164 and accelerator 159 then pass into a slurry cavity 166 where slurry (e.g., sprayable cementitious material) is fed. In this manner, the pressurized pneumatic stream comprising accelerator combines with the sprayable cementitious material so that mixing occurs to form a pressurized slurry material that can exit the nozzle 56 and create the second supply 42C. Like the embodiment described above, the addition of the accelerator at 159 thus accelerates activation and setting of the cementitious material as it is applied to the target 48.

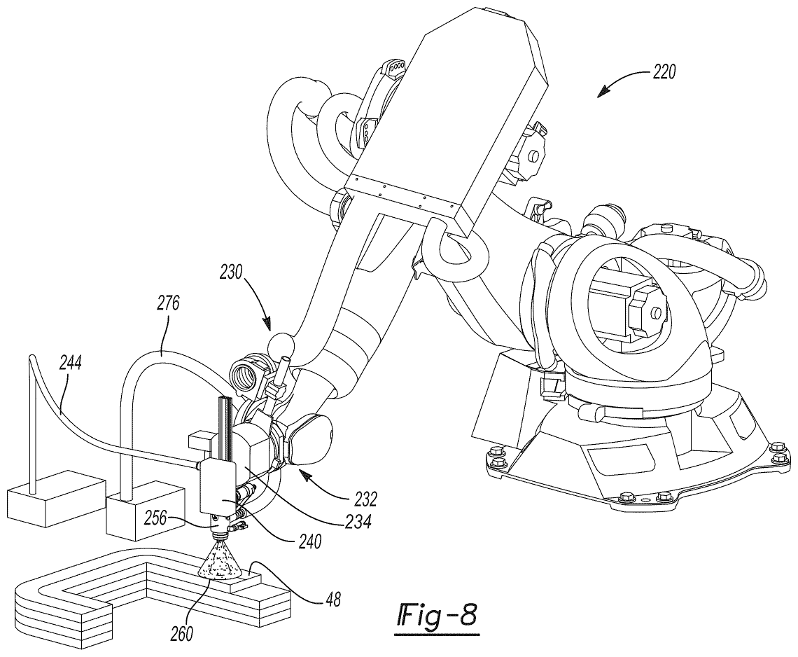

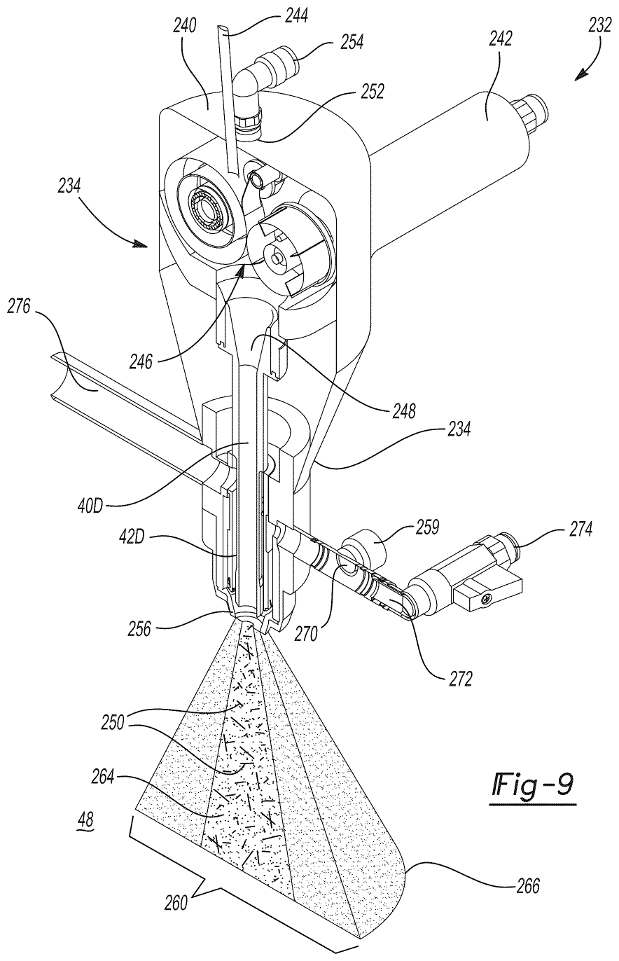

FIG. 8 shows an automated spraying device 220 prepared in accordance with certain aspects of the present disclosure. As will be described further herein, the automated spraying device 220 is configured to conduct an additive spraying process by generating a concentric stream from a nozzle that includes a central region and a surrounding concentric or peripheral region, as described further herein. Further, additives, such as accelerator, may be introduced to deliver the sprayable cementitious material or low viscosity slurry. The device 220 comprises a feed system 230 and an automated spray system 232. To the extent that the components of automated spraying device 220 are the same or similar in function to those in automated spraying devices 20, 20A, 20B, and 120 discussed above in the context of FIGS. 1-4 and 7, they will not be reintroduced or discussed again herein for brevity. An automated spray system 232 includes an automated spray head 234, which is shown in more detail in FIG. 9, and may be digitally controlled as discussed above.

The feed system 230 includes a first supply line 40D configured to deliver fibers at the spray head 234 of the automated spray system 232. The first supply line 40D is associated with and in fluid communication with a fiber chopper device 240. The fiber chopper device 240 has a motor 242 that chops an elongated feed fiber 244 into a plurality of chopped fibers 250 in an internal chopping region 246 including various internal chopping rollers and components that form part of a chopping mechanism. It will be appreciated that fiber chopper device 240 may operate in a similar manner to the fiber chopper device 140 in FIG. 7 and thus will not be discussed again herein in detail. The first supply line 40D may be pneumatic and in fluid communication with a pressurized gas. In this variation, the fiber chopper device 240 also has an inlet 252 that receives a pressurized gas (e.g., air) supply 154, for example, from a compressed gas source. The pressurized air from the pressurized air supply 254 and chopped fibers 250 then pass into a fiber cavity 248 in fluid communication with or defining a central region of a nozzle 256.

The automated spray system 232 at the spray head 234 also includes a second supply line 42D configured to deliver the sprayable cementitious material or low viscosity slurry at nozzle 256. The automated spray system 232 and automated spray head 234 may be digitally controlled and coordinated with one another like embodiments discussed above as discussed above.

In the automated spraying device 220, additives, such as accelerator, may be introduced to the second supply line 42D that is configured to deliver the sprayable cementitious material or low viscosity slurry. For example, where the sprayable slurry material is a sprayable cementitious material, for example, comprising ordinary Portland cement, the spraying of a second sprayed stream 266 may further comprise introducing an accelerator via an accelerator supply line 259 (connected to an upstream supply of accelerator or additive not shown in FIGS. 8 and 9) that enter an inlet 270 of line 272. The second supply line 42D may be pneumatic and in fluid communication with a pressurized gas. As described above, the second supply 42D may be pneumatic and in fluid communication with a pressurized gas. Thus, the line 272 receives a pressurized gas (e.g., air) supply 274, for example, from a compressed gas source. The pressurized air delivered from the pressurized air supply 274 and accelerator 259 then combine with slurry material entering from a slurry supply line 276 that mix together into second supply line 42D where slurry (e.g., sprayable cementitious material) is fed into the spray head 234 of the nozzle 256. In this manner, the pressurized pneumatic stream comprising accelerator combines with the sprayable cementitious material so that mixing occurs to form a pressurized slurry material that can exit the nozzle 256 in a peripheral region (a concentric shell sprayed around the core region or central spray stream) to create the second supply line 42D. Like the embodiment described above, the addition of the accelerator at 259 thus accelerates activation and setting of the cementitious material as it is applied to the target 48.

The nozzle 256 is configured to deliver a concentric sprayed stream 260 directed towards the target 48 that includes a first sprayed stream 264 comprising fibers 250 in a central region and a second sprayed stream 266 comprising cementitious materials/slurry in a peripheral region (or a concentric shell surrounding the first sprayed stream 264 in the central region) Thus, the two distinct sprayed streams (264, 266) combine at the nozzle 256 of the automated spray head 234 to generate a combined concentric sprayed stream 260 where the fibers and cementitious materials are mixed together as they are deposited on the target 48.

As discussed above, the sprayable composition for additive manufacturing has a fresh state, where the composition may be in a liquid or semi-liquid phase and thus sprayable for the additive manufacturing spraying process. As noted above, in certain variations, the sprayable composition is a cementitious composition, such as a slurry comprising a cementitious material. The properties of such a sprayable cementitious composition in a fresh state include sprayability, while after hydraulic setting and reaction proceeds, the cementitious composition is in a hardened state. In various aspects, the sprayable cementitious composition comprises a cementitious material, which may include a cement or pozzolan. In certain variations, the cementitious composition comprises Portland cement, an aggregate, such as a fine aggregate, water, and other typical ingredients known to those of skill in the art for sprayable cementitious compositions, such as fly ash, plasticizers, accelerators, and the like.

In alternative aspects, the present technology may include a fiber-reinforced composition where the slurry that is sprayed may include clay, earth-based materials, starch, and the like. The material has a viscosity such that it can be pumped and within a material atomization range when being sprayed. A reinforced composite material is thus formed with a slurry precursor having low viscosity that is both pumpable and sprayable. Further, an accelerator may be added at the spraying nozzle or after spraying to allow for an on-demand setting.

A Portland cement typically comprises inorganic compounds, such as dicalcium silicate (C₂S or 2CaO.SiO₂), tricalcium silicate (C₃S or 3CaO.SiO₂), tricalcium aluminate (C₃A or 3CaO.Al₂O₃), and tetracalcium aluminoferrite (C₄AF or 4CaO.Al₂O₃.Fe₂O₃), which may be hydrated. Commercially available Portland cement often includes additives, such as gypsum (calcium sulfate) that serves as a set retardant, and pozzolans, like fly ash and ground granulated blast furnace slags (GGBFS), that can react with calcium hydroxide and water to form calcium silicate hydrates or calcium aluminate hydrates. When pozzolans are added to Portland cement, they are considered to be blended cements. ASTM, International Test C 150 called the “Standard Specification for Portland Cement” provides eight types of ordinary Portland cement for different applications, namely: Types I, IA, II, IIA, III, IIIA, IV, and V. In certain non-limiting aspects, the Portland cement used in the cementitious composition is Type I. The Portland cement may be present in the cementitious composition at greater than or equal to about 50 mass/weight % to less than or equal to about 98 mass % of the total mass of cementitious binder components, optionally at greater than or equal to about 60 mass/weight % to less than or equal to about 90 mass % of the total mass of cementitious binder components, and in certain variations, optionally at about 72% by mass of the total mass of the cementitious binder components.

In certain variations, the sprayable cementitious composition further comprises a fly ash that can be added to the cementitious composition and serves as a pozzolan/cementitious material. Fly ash is an industrial byproduct, for example, collected from effluent of a coal burning boiler unit. It can be used as a substitute for a portion of the Portland cement to reduce energy consumption required to form the overall product and increase the environmental friendliness of the cementitious composition, while contributing to the cementitious properties of the matrix/binder system of the concrete composite. In one variation, the fly ash may be a Class F fly ash as designated by ASTM C618, which is formed from combustion of anthracite and/or bituminous coals. ASTM C618 requires that Class F fly ash contain at least 70% pozzolanic compounds (silica oxide, alumina oxide, and iron oxide). The fly ash may be present in the cementitious composition at 0 mass/weight % to less than or equal to about 45 mass % of the total mass of cementitious binder components, optionally at 0 mass % to less than or equal to about 35 mass % of the total mass of cementitious binder components, an in certain aspects, optionally at about 23 mass % of the total mass of cementitious binder components. In other aspects, the fly ash may be present in the cementitious composition at 0 mass % to less than or equal to about 25 mass % of the total cementitious composition.

The sprayable cementitious composition may also include a fine aggregate, such as an inert sand or inert finely crushed stone. Fine aggregates may have a particle size distribution having approximately 95% passing on a 9.5 mm sieve (⅜ inch sieve). In certain variations, the fine aggregate is sand. The solid aggregate is distributed within the cementitious matrix to form a composite. In certain variations, the aggregate may be substantially homogeneously distributed within the cementitious composite (e.g., concrete) that is formed. The fine aggregate may comprise sand that has an average particle size of less than or equal to about 2 mm. In one non-limiting variation, the aggregate may be an F-75 silica or quartz sand commercially available from U.S. Silica. The fine aggregate may be present in the cementitious composition at greater than or equal to about 20 mass/weight % to less than or equal to about 65 mass % of the total mass of cementitious binder components, optionally at greater than or equal to about 30 mass/weight % to less than or equal to about 60 mass % of the total mass of cementitious binder components, and in certain variations, optionally at about 45 mass % of the total mass of cementitious binder components.

The cementitious composition also includes a high range water reducing agent (HRWRA), also known as a plasticizer/superplasticizer. Inclusion of the HRWRA can serve to reduce water content needed in the cementitious composition by about 10% to about 30%. The HRWRA can create high fluidity with good flowability properties for the sprayable cementitious composition, contributing to making the cementitious composition suitable for spraying via additive manufacturing by helping to eliminate the need for any vibration or compaction after deposition. An example of a suitable HRWRA is a low viscosity polycarboxylate based high-range water-reducing admixture commercially available from W.R. Grace as ADVA® 190. The HRWRA may be present in the cementitious composition at greater than or equal to about 0.3 mass/weight % to less than or equal to about 1.5 mass % of the total mass of cementitious binder components.

Water is also included in the sprayable cementitious composition. A mass ratio of water to cementitious binder components (e.g., Portland cement, and any other pozzolanic materials, like fly ash) may be greater than or equal to about 0.2 to less than or equal to about 0.55. In one variation, a mass ratio of water to cementitious binder components is about 0.43. Water temperature can be used to intentionally manipulate the fresh state properties of a particular cementitious material composition. Water temperature affects fresh state rheological properties due to the accelerated activation of pozzolanic reactions of the cementitious materials. Water may be present in the cementitious composition at greater than or equal to about 10 mass % to less than or equal to about 35 mass % of the total cementitious composition. In one variation, the water may be present at about 20 to about 21% by mass of the total composition (e.g., about 20.7%).

As discussed above, the fiber-reinforced cementitious composite structure comprises at least one type of fiber distributed within the cementitious matrix to form a composite (in combination with the aggregate solid material). In certain variations, the plurality of fibers may be substantially homogeneously distributed within the cementitious composite (e.g., concrete) that is formed. In certain aspects, the fibers may have a single composition or may include a mixture of different compositions or other combinations of select properties, such as different lengths or diameters. The fibers may include a variety of distinct materials, such as carbon fibers, glass (e.g., fiberglass, quartz, silica, borosilicates, etc.), polymer fibers (e.g., polyvinyl alcohol (PVA) or polyalkylene fibers, such as polyethylene (PE) or polypropylene (PP), including high tenacity polypropylene (HTPP) fibers), aramid fibers (such as KEVLAR™ para-aramid synthetic fibers and TWARON™ para-aramid synthetic fibers)), basalt fibers, boron fibers, ceramic fibers, natural fibers, including plant-based fibers (derived from plants) and animal-based fibers (derived from animals), such as sisal, jute, hemp, bamboo, curaua fibers, cellulose-based fibers, goat hair, and the like, artificial fibers, and any combination thereof.

An aspect ratio or ratio between a length of the fiber (L) and a diameter (D) of the fiber (AR=L/D) may be greater than or equal to about 150. In certain variations, the AR may be greater than or equal to about 150 to less than or equal to about 900.

In certain variations, a suitable fiber may have a length of greater than or equal to about 4 mm to less than or equal to about 20 mm, optionally greater than or equal to about 6 mm to less than or equal to about 15 mm, optionally greater than or equal to about 8 mm to less than or equal to about 12 mm, and in certain variations, optionally greater than or equal to about 8 mm to less than or equal to about 10 mm. In certain variations, a fiber in the fiber-reinforced cementitious composite structure has a diameter of greater than or equal to about 10 micrometers (um) to less than or equal to about 200 μm. In one variation, the fiber is a glass fiber. In another variation, the fiber is a carbon fiber. The fiber may be present in the fiber-reinforced cementitious composite structure at greater than or equal to about 1 vol. % to less than or equal to about 4.5 vol. % of the total volume of the fiber-reinforced cementitious composite structure, optionally at greater than or equal to about 1.8 vol. % to less than or equal to about 4 vol. %, and in certain variations, optionally at about 2 vol. %.

The robotic additive spraying devices can thus be used to spray the fiber and sprayable cementitious material from two, three, or more separate numerically controlled nozzles in a sprayed layer by sprayed layer method to fabricate a three-dimensional structural concrete elements. The RAS technology is adaptable to almost any feedstock materials including, but not limited to fibers, and may include other reinforcement materials, such as particles. Thus, the inventive technology may be used to form a multitude of composite materials and can apply to a variety of industries beyond concrete construction. The RAS technology is adaptable to almost any feedstock materials and may thus be used to spray earth, clays, silicas, geo-polymers, liquid-polymers, bio-hemp, wood or metal fibers, by way of non-limiting example at small or large scales applicable to various industries, including construction, aerospace, automobile, and defense, by way of non-limiting example.

In various aspects, the present technology can provide one or more of the following benefits: (1) significantly reduce or eliminate the “cold joint” problem between layers, increase vertical interlayer and horizontal filament bonding strength and ductility by at least 80%, and thus structural stability for both lateral and tensile loads; (2) significantly reduce shrinkage cracking of 3D printed concrete as result of integration of higher fiber content with pressure and functional grading; (3) significantly reduce the need for traditional continuous reinforcement, which is generally incompatible with complex topology optimized geometries via tailored functional grading of fiber content; (4) enable the creation of new civil infrastructure composite components and structures with multifunctional and functionally graded properties; (5) increase sustainability in the concrete construction industry. This increased sustainability may occur by a) eliminating concrete waste by placing material only where it is needed, as well as eliminating the need for formwork and b) enabling structural designs with superior mechanical performance and durability, reducing maintenance energy.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An automated spraying device for additive manufacturing, the device comprising:
a feed system comprising a first supply configured to deliver fibers and a second supply configured to deliver a sprayable slurry matrix material; and
an automated spray head that comprises at least one nozzle in communication with the first supply and/or the second supply, wherein the at least one nozzle is configured to deliver at least one sprayed stream comprising the fibers or the sprayable slurry matrix material, wherein the automated spraying system is configured to form a layer of reinforced composite material from the at least one sprayed stream comprising the fibers and the sprayable slurry matrix material on a target.

2. The automated spraying device of claim 1, wherein the at least one nozzle includes a first nozzle and a second nozzle and the automated spray head comprises the first nozzle in communication with the first supply and the second nozzle in communication with the second supply, wherein the at least one sprayed stream further comprises a first sprayed stream and a second sprayed stream, wherein the first nozzle is configured to deliver the first sprayed stream comprising fibers and the second nozzle is configured to deliver the second sprayed stream comprising the sprayable slurry matrix material, wherein the automated spraying system is configured to form a layer of reinforced composite material from the first sprayed stream comprising fibers from the first nozzle and the second sprayed stream comprising the sprayable slurry matrix material from the second nozzle on the target.

3. The automated spraying device of claim 1, wherein the automated spray head further comprises a first chamber and a second chamber and the at least one nozzle defines a central region and a peripheral region, wherein the first chamber is in communication with the first supply and the central region of the at least one nozzle and the second chamber is in communication with the second supply and the peripheral region of the at least one nozzle.

4. The automated spraying device of claim 1, wherein the feed system further comprises a fiber chopper that comprises a motor and is configured to chop a feed fiber into the fibers delivered in the first supply to the at least one nozzle.

5. The automated spraying device of claim 1, wherein the automated spray head is disposed on at least one robotic device or a computer numerical control (CNC) gantry, and the automated spray head is at least partially controlled by a computer numerical control (CNC) system and/or the at least one nozzle is at least partially controlled individually by a computer numerical control (CNC) system.

6-7. (canceled)

8. The automated spraying device of claim 1, wherein the at least one sprayed stream is a pneumatically sprayed stream and the first supply is pressurized and in fluid communication with a first compressed gas source and the second supply is pressurized and in fluid communication with a second compressed gas source.

9. The automated spraying device of claim 1, wherein the fibers are selected from the group consisting of: glass fibers, carbon fibers, plant-based fibers, animal-based fibers, and combinations thereof and the sprayable slurry matrix material comprises an ordinary Portland cement, a fine aggregate, and water.

10. The automated spraying device of claim 1, wherein the automated spray head further comprises an additional nozzle in addition to the at least one nozzle in communication with a third supply, wherein the additional nozzle is configured to deliver an additional sprayed stream comprising solid particles.

11. A method of additive spraying of a reinforced composite material, the method comprising:
spraying at least one stream comprising fibers and a sprayable slurry matrix material from at least one outlet on an automated spray head towards a target;
forming a first sprayed layer of reinforced composite material from the at least one stream of the fibers and slurry matrix material on the target; and
repeating the spraying of the at least one stream forming at least one additional sprayed layer of reinforced composite material over the first sprayed layer.

12. The method of claim 11, wherein the spraying at least one stream further comprises spraying a first stream comprising the fibers from a first nozzle on the automated spray head towards the target; and
spraying a second stream comprising the sprayable slurry matrix material from a second nozzle on the automated spray head towards the target, wherein
the forming the first sprayed layer of reinforced composite material comprises the combined first stream and the second stream on the target; and
the repeating the spraying comprises repeating spraying of the first stream and the second stream and forming the at least one additional sprayed layer of reinforced composite material over the first sprayed layer.

13. The method of claim 12, wherein the spraying the first stream and the second stream towards the target occur concurrently and the first stream and the second stream combine together and are deposited on the target as a combined stream.

14. (canceled)

15. The method of claim 12, wherein the spraying the first stream and the second stream towards the target occur sequentially to one another.

16. The method of claim 12, wherein the spraying the first stream occurs at a first flow rate for a first duration so that the fibers are present at a first concentration in the reinforced composite material and the method further comprises adjusting the spraying of the first stream to a second flow rate distinct from the first flow rate for a second duration so that the fibers are present at a second concentration distinct from the first concentration in the reinforced composite.

17. The method of claim 11, wherein the fibers are selected from the group consisting of: glass fibers, carbon fibers, plant-based fibers, animal-based fibers, and combinations thereof and the sprayable slurry matrix material comprises an ordinary Portland cement, a fine aggregate, and water.

18. The method of claim 11 further comprising spraying an additional stream comprising solid particles from an additional nozzle on the automated spray head towards the target, wherein the forming of the first sprayed layer of reinforced composite material comprises the combined at least one stream and the additional stream on the target; and
the repeating of the spraying of the at least one stream and the additional stream forms the at least one additional sprayed layer of reinforced composite material over the first sprayed layer.

19. The method of claim 18, wherein the spraying of the additional stream occurs at a first flow rate for a first duration so that the solid particles are present at a first concentration in the reinforced composite material and the method further comprises adjusting the spraying of the additional stream to a second flow rate distinct from the first flow rate for a second duration so that the solid particles are present at a second concentration distinct from the first concentration in the reinforced composite.

20. The method of claim 11, wherein the target is a planar substrate, a mold or form having a contoured surface, or a previously sprayed layer of reinforced cementitious composite.

21-22. (canceled)

23. The method of claim 11, wherein the sprayable slurry matrix material is a sprayable cementitious material and the spraying of the at least one stream further comprises introducing an accelerator into the sprayable cementitious material so that mixing occurs in the automated spray head that accelerates activation of the cementitious material.

24. The method of claim 11, further comprising chopping a feed fiber into the fibers prior to the spraying the at least one stream comprising the fibers.

25. An automated spraying device for additive manufacturing, the device comprising:
a feed system comprising a first supply line configured to deliver fibers and a second supply line configured to deliver a sprayable slurry matrix material; and
an automated spray head that comprises:
a first nozzle in communication with the first supply line, the first nozzle configured to deliver a first sprayed stream comprising fibers; and
a second nozzle in communication with the second supply line and configured to deliver a second sprayed stream comprising a sprayable slurry matrix material, wherein the automated spraying system is configured to form a layer of reinforced composite material from the first sprayed stream comprising fibers from the first nozzle and the second sprayed stream comprising the sprayable slurry matrix material from the second nozzle on a target.

26-40. (canceled)
